(19) United States
(12) Patent Application Publication
(10) Pub. No.: US 2012/0082863 A1
(43) Pub. Date: Apr. 5, 2012

(54) Optical film, polarizing plate, image display, and manufacturing method of optical film

(75) Inventors: Jyunko Ohta, Kanagawa (JP); Takato Suzuki, Kanagawa (JP)

(73) Assignee: FUJITIFILM Corporation, Tokyo (JP)

(21) Appl. No.: 13/200,717

(22) Filed: Sep. 29, 2011

(30) Foreign Application Priority Data
Sep. 30, 2010 (JP) 2010-223286

(51) Int. Cl. B32B 27/30; B05D 5/06

(52) U.S. Cl. 428/522; 427/164

(57) ABSTRACT

An optical film includes: a transparent base material; and a hard coat layer with a refractive index of 1.45 to 1.55, which is formed of a composition containing the following (a), (b) and (c): (a) a compound having two or less functional groups in one molecule, having a mass average molecular weight Mwa satisfying 40<Mwa<500, and satisfying 19<SPa<24.5; (b) a compound having three or more functional groups in one molecule, having a mass average molecular weight Mwb satisfying 100<Mwb<1,600 and 70<(Mwb/(the number of functional groups in one molecule))<300, and SPb satisfying 19<SPb<24.5; and (c) a solvent capable of dissolving and swelling the transparent base material. A content of the compound (a) is 0.5 to 10% by mass to that of the compound (b). SPa and SPb are SP values defined by Hoy method.

This application is based on and claims priority under 35 U.S.C. §119 from Japanese Patent Application No. 2010-223286, filed Sep. 30, 2010, the entire disclosure of which is herein incorporated by reference.

### BACKGROUND OF THE INVENTION

1. Field of the Invention

The present invention relates to an optical film, a polarizing plate, an image display, and a manufacturing method of the optical film.

2. Background Art

In image display devices such as a cathode ray tube (CRT), a plasma display panel (PDP), an electroluminescence display (ELD), a vacuum fluorescent display (VFD), a field emission display (FED), and a liquid crystal display (LCD), it is preferred to provide a hard coat film having a hard coat layer on a transparent base material to prevent scratching of display surface.

Further, in the case of highly precise and high grade image display such as LCD in recent years, in addition to the prevention of scratching on the display surface, for preventing contrast reduction and mirroring of images which are caused by reflection of outer light on the display surface, and preventing, an antireflection layer or an optical film having an antireflection layer is provided on a hard coat layer.

In such an optical film provided with a hard coat layer, interference fringes occurs by interference between light reflected by interface of a transparent base material and the lard coat layer and reflected light from the hard coat layer surface, and further there are cases where tinted interference fringes occur. Since interference fringes damage visibility of the displayed image of image display device and grade of the image, the improvement thereof is required.

JP-A-2004-263082 discloses that interference fringes can be improved, for example, in forming a hard coat layer by coating a coating solution mainly including an organic solvent and a resin component on a film substrate, by dissolving (swelling) the surface of the film substrate by the coating solution to thereby integrate the interface of the hard coat layer and the film substrate.

JP-A-2006-299221 discloses, for the purpose of restraining the occurrence of interference fringes by interface reflection, forming a hard coat layer from a composition containing two kinds of resins having different average molecular weights and the number of functional groups, and a solvent permeable through a base material. JP-A-2007-237483 discloses forming a hard coat layer by curing a resin having a radical polymerizable functional group and a low molecular weight resin having a cation polymerizable functional group, and permeating the resin having a cation polymerizable functional group through the base material and curing, for the purpose of preventing curl and improving adhesion of the base material and the hard coat layer, in addition to prevention of the occurrence of interference fringes by interface reflection.

Although there is no description in regard to interference fringes, JP-A-2009-186760 describes a hard coat layer-forming composition containing two kinds of monomers of pentaerythritol tetraacrylate and hydroxyethyl methacrylate, zirconium oxide, and ethyl acetate and acetone as solvents.

### SUMMARY OF THE INVENTION

Interference fringes generated by interface reflection between a transparent base material and a hard coat layer are controlled to a certain degree according to the methods as disclosed in JP-A-2004-263082, JP-A-2006-299221, and JP-A-2007-237483. However, image displays in recent years are high in contrast ratio and a demand for high grade images having denseness of black has increased. Further, interference fringes are prone to be emphasized under a three band light source and interference fringes control of a higher level is required in proportion to these circumstances.

Interface reflection which causes interference fringes is liable to occur when a difference in refractive index between a transparent base material and a hard coat layer is large and a clear boundary exists between both. The hard coat layer obtained by curing the composition containing two kinds of monomers of pentaerythritol tetraacrylate and hydroxyethyl methacrylate, and zirconium oxide (about 1.64) as described in JP-A-2009-187670 is high in refractive index (about 1.58) for containing zirconium oxide, and it is supposed that interference fringes cannot be sufficiently restrained.

It has been found from the results of investigations by the present inventors, that, in regard to the base materials as disclosed in JP-A-2004-263082, JP-A-2006-299221, and JP-A-2007-237483, depending upon the degree of dissolution of base materials or permeation through base materials of the solvent having solubility or solvent having permeability, there are cases where the hard coat layer side of the transparent base material strongly receives a shrinkage accompanied by curing in forming the hard coat layer to thereby cause curl, or there are cases where the interface between the base material and the hard coat layer does not disappear, so that interface reflection cannot be effectively suppressed.

An object of the invention is to provide an optical film restrained in interference fringes, having sufficient hardness, and controlled in curl.

Other objects of the invention are to provide a manufacturing method of the optical film, a polarizing plate using the optical film as a protective film of the polarizing plate, and an image display having the optical film or the polarizing plate.

As a result of earnest examinations by the present inventors for achieving the above objects, it has been found that interference fringes can be drastically restrained by using a solvent having the properties capable of dissolving and swelling a base material as the solvent for use in a hard coat layer-forming composition, by that means the base material is effectively mixed with the monomer by permeation of the monomer through the base material due to swelling of the base material and dissolution of the base material itself so that the interface of the base material and the hard coat layer disappears. It has also been found that by using a low molecular weight monomer having good affinity with the base material (low in SP value), permeation of the monomer through the base material progresses and the base material is effectively mixed with the hard coat layer, and by the use of the low molecular weight monomer having a smaller functional group number, curl can be prevented. On the other hand, a hard coat layer having high hardness can be obtained by using a polyfunctional monomer having low permeability through a base material and high molecular weight.

That is, the above objects can be accomplished by the following means.

[1]

An optical film comprising: a transparent base material; and a hard coat layer formed of a composition for forming the hard coat layer, the composition containing following (a), (b) and (c):

(a) a first compound having two or less functional groups in one molecule, the first compound having a mass average molecular weight Mwa that satisfies 40<Mwa<500 and having a SP value SPa that satisfies 19<SPa<24.5, wherein the SP value is defined by the Hoy method,

(b) a second compound having three or more functional groups in one molecule, the second compound having a mass average molecular weight Mwb that satisfies 100<Mwb<1,600 and 70<(Mwb/(number of functional groups in one molecule))<300 and having a SP value SPb that satisfies 19<SPb<24.5, wherein the SP value is defined by the Hoy method, and

(c) a solvent capable of dissolving and swelling the transparent base material,

wherein the hard coat layer has a refractive index of 1.45 to 1.55, and a content of the first compound (a) is from 0.5% by mass to 10% by mass to a content of the second compound (b).

[2]

The optical film as described in [1], wherein the solvent (c) contains at least one of methyl acetate, acetone and methyl ethyl ketone.

[3]

The optical film as described in [1] or [2], wherein Mwa of the first compound (a) satisfies 30<Mwa<250.

[4]

The optical film as described in any one of [1] to [3], wherein SPa of the first compound (a) satisfies 22<SPa<24.5.

[5]

The optical film as described in any one of [1] to [4], wherein the composition contains two or more compounds as the second compound (b), at least one of which is a urethane compound.

[6]

The optical film as described in any one of [1] to [5], wherein the solvent (c) contains at least one first solvent capable of dissolving the transparent base material, and at least one second solvent having capable of swelling the transparent base material, wherein a proportion of the first solvent is higher than a proportion of the second solvent in all solvents.

[7]

The optical film as described in any one of [1] to [6], wherein the transparent base material is a cellulose acylate film.

[8]

The optical film as described in any one of [1] to [7], wherein the hard coat layer has a haze of 1.0% or less.

[9]

An optical film comprising: a transparent base material; and a hard coat layer having a haze of 1.0% or less, wherein the optical film has a peak strength PV value of a power spectrum of 0.000 to 0.006, the power spectrum being obtained by a Fourier transform of a reflectance spectrum of the optical film measured by an optical interferometry.

[10]

The optical film as described in [9], wherein the PV value is 0.000 to 0.003.

[11]

A polarizing plate comprising an optical film described in any one of [1] to [10] as a protective film for the polarizing plate.

[12]

An image display comprising an optical film described in any one of [1] to [10] or a polarizing plate described in [11].

[13]

A method for manufacturing an optical film described in any one of [1] to [8], the method comprising: coating the composition for forming the hard coat layer on the transparent base material; and curing the composition to form the hard coat layer.

### BRIEF DESCRIPTION OF THE DRAWING

FIG. 1 is a drawing to explain light interference of a thin film.

FIG. 2 is a drawing showing an example of a reflectance spectrum of a thin film obtained by an optical interferometry.

### DETAILED DESCRIPTION OF THE INVENTION

According to an exemplary embodiment of the invention, it is possible to provide an optical film that is restrained in interference fringes, having sufficient hardness and controlled in curl.

Exemplary embodiments of the invention will be described in detail below, but the invention is not restricted thereto. In this specification, when numerical values mean physical values and characteristic values, the description “from (numerical value 1) to (numerical value 2)” means “numerical value 1 or more and numerical value 2 or less”. Further, in the specification of the invention, the description of “(meth)acrylate” indicates the meaning of “at least either acrylate or methacrylate”. “(Meth)acrylic acid” and “(meth)acryloyl” are also the same.

Furthermore, “a repeating unit corresponding to a monomer” or “a repeating unit deriving from a monomer” in the invention means that a component obtained after polymerization of the monomer becomes a repeating unit.

### <Optical Film>

As one exemplary embodiment of the optical film in the invention is an optical film having a hard coat layer on a transparent base material formed of a hard coat layer-forming composition containing the following (a), (b) and (c):

(a) a compound (first compound) having two or less functional groups in one molecule, a mass average molecular weight Mwa of which is 40<Mwa<500, and an SP value SPa defined by the Hoy method of which is 19<SPa<24.5,

(b) a compound (second compound) having three or more functional groups in one molecule, a mass average molecular weight Mwb of which is 100<Mwb<1,600, an SP value SPb defined by the Hoy method of which is 19<SPb<24.5, and 70<(Mwb/(number of functional groups in one molecule))<300, and

(c) a solvent capable of dissolving and swelling the transparent base material,

in which the refractive index of the hard coat layer is 1.45 or more and 1.55 or less, and the content of (a) to (b) is 0.5% by mass or more and 10% by mass or less.

When a hard coat layer is formed on a transparent base material with a hard coat layer-forming composition of the above constitution, interface reflection between the transparent base material and the hard coat layer is restrained and interference fringes can be controlled. In particular, when a cellulose ester film (a cellulose acylate film, above all) is used as the transparent base material, controlling effect of interference fringes is great. This is presumed for the reason that the following mechanism functions. That is to say, compounds (a) and (b) permeate through the cellulose ester film with swelling of the cellulose ester film by solvent (c). Further, the cellulose ester diffuses on the hard coat layer side by dissolution of the cellulose ester film by means of solvent (c). Since compounds (a) and (b) differ in the degree of permeation through the transparent base material, a region in which distribution of the compounds gradually changes from the cellulose ester film side toward the hard coat layer side (hereinafter referred to as “a gradation region” or “a gradation layer”) is formed between the cellulose ester film and the hard coat layer. Therefore, transition of the refractive index between the cellulose ester film and the hard coat layer becomes very gentle (i.e., the interface disappears) and interface reflection is restrained, thereby preventing interference fringes. Incidentally, if the distribution of the compounds from the hard coat layer toward the base material smoothly varies at the interface therebetween, interference fringes can be prevented.

A hard coat layer-forming composition is described in detail below.

### <Hard Coat Layer-Forming Composition>

### <(a) Compound Having Two or Less Functional Groups in One Molecule>

(a) A compound having two or less functional groups in one molecule contained in the hard coat layer-forming composition according to the invention is described below.

(a) A compound having two or less functional groups in one molecule for use in the invention is a compound having a mass average molecular weight Mwa of 40<Mwa<500, and an SP value Spa defined by the Hoy method of 19<SPa<24.5. A compound having such a molecular weight and SP value is easily permeated through a cellulose ester film and so a preferred compound to form a gradation region between a cellulose ester film and a hard coat layer. Since the number of functional groups is two or less, a shrinkage at the time of curing is small, and curl does not occur even when the compound is permeated on the cellulose ester film side and cured.

The number of functional groups in one molecule is preferably 1 or 2, and more preferably 1.

As (a) compounds having two or less functional groups in one molecule, compounds having a polymerizable functional group (a polymerizable unsaturated double bond) such as a methacryloyl group, a vinyl group, a styryl group, or an allyl group are exemplified, and compounds having a methacryloyl group or —C(O)OCH═CH₂ are preferred.

The specific examples of (a) compounds having two or less functional groups in one molecule include:

Alkylene glycol (meth)acrylic diesters, e.g., neopentyl glycol diacrylate, 1,6-hexanediol di(meth)acrylate, ethylene glycol di(meth)acrylate, and propylene glycol di(meth)acrylate;

Polyoxyalkylene glycol (meth)acrylic diesters, such as polyethylene glycol di(meth)acrylate having 8 or less repeating number of ethylene unit, e.g., diethylene glycol di(meth)acrylate and triethylene glycol di(meth)acrylate, and polypropylene glycol di(meth)acrylate having 6 or less repeating number of propylene unit, e.g., dipropylene glycol di(meth)acrylate and tripropylene glycol di(meth)acrylate;

Polyhydric alcohol (meth)acrylic diesters, e.g., pentaerythritol di(meth)acrylate, 1,4-cyclohexanediacrylate, and tricyclodecanedimethanol di(meth)acrylate;

Ethylene oxide adduct (meth)acrylic diesters, e.g., 2,2-bis[4-(methacryloxy-ethoxy)phenyl]propane and 2,2-bis[4-(acryloxy-diethoxy)phenyl]propane; and

Monofunctional (meth)acrylic esters, e.g., isobornyl (meth)acrylate, octyl (meth)acrylate, decyl (meth)acrylate, aliphatic epoxy (meth)acrylate, ethoxylated phenyl (meth)acrylate, β-carboxyethyl (meth)acrylate, methoxy polyethylene glycol (meth)acrylate, phenoxy polyethylene glycol (meth)acrylate, 2-(meth)acryloyloxyethyl succinate, glycerol mono(meth)acrylate, 2-hydroxyethyl (meth)acrylate, cyclohexyl (meth)acrylate, and lauryl (meth)acrylate.

A mass average molecular weight Mwa of (a) a compound having two or less functional groups in one molecule is 40<Mwa<500. From the viewpoint of restraint of interference fringes by formation of gradation region, Mwa is preferably 40<Mwa<400, and more preferably 40<Mwa<200.

The mass average molecular weight is measured as a polystyrene equivalent mass average molecular weight by gel permeation chromatography.

An SP value SPa defined by the Hoy method of (a) a compound having two or less functional groups in one molecule is 19<SPa<24.5. From the viewpoint of restraint of interference fringes by formation of gradation region, SPa is preferably 19.5<SPa<24.5, and more preferably 20<SPa<24.5.

The SP (solubility parameter) value in the invention is a value computed by the Hoy method. The Hoy method is described in Polymer Handbook, Fourth Edition.

As (a) a compound having two or less functional groups in one molecule, commercially available products can also be used, and, for example, Blenmer E, Blenmer PE-90, Blenmer GMR, Blenmer PME-100, Blenmer PME-200, Blenmer PME-400, Blenmer PDE-200, Blenmer PDE-400 (manufactured by NOF Corporation), ABE10, ABE300, A-200, A-400 (manufactured by Shin-Nakamura Chemical Co., Ltd.), Viscoat #195 (manufactured by Osaka Organic Chemical Industry Ltd.), and EB4858 (manufactured by Daicel Chemical Industries, Ltd.) can be exemplified.

A content of (a) compound having two or less functional groups in one molecule in the hard coat layer-forming composition according to the invention is 0.5% by mass or more and 10% by mass or less based on the polyfunctional materials contained in the hard coat layer-forming composition, preferably 0.5% by mass to 9% by mass, and more preferably 0.5% by mass to 8% by mass. By increasing the addition amount of compound (a), curl restraint is conspicuously bettered, but addition of an excessive amount sometimes results in the reduction of pencil hardness, so that the above range of addition amount is preferred from the viewpoint of taking the region of high hardness while bettering curl.

However, the optimal range of the above addition amount may deviate by ±5% with a monofunctional compound and a bifunctional compound. This is for the reason that improving effect of curl restraint is higher in the case of using a monofunctional compound as compound (a) as compared with the case of using a bifunctional compound as compound (a).

### <(b) Compound Having Three or More Functional Groups in One Molecule>

(b) A compound having three or more functional groups in one molecule contained in the hard coat layer-forming composition according to the invention is described below.

(b) A compound having three or more functional groups in one molecule for use in the invention is a compound having a mass average molecular weight Mwb of 100<Mwb<1,600, an SP value SPb defined by the Hoy method of 19<SPb<24.5, and 70<(Mwb/(number of functional groups in one molecule))<300. A compound having such a molecular weight and SP value is difficult to permeate through a cellulose ester film but the compatibility with the cellulose ester is good as compared with (a) a compound having two or less functional groups in one molecule, so that a gradation region can be formed and the boundary of refractive indices between the gradation layer and the hard coat layer can also be substantially got rid of by the use of compound (b) in combination with compound (a).

Further, (b) a compound having three or more functional groups in one molecule can function as a binder and curing agent of a hard coat layer, so that it becomes possible to improve hardness and scratch resistance of the film.

The number of functional groups in one molecule is preferably 3 to 20, more preferably 3 to 10, and still more preferably 3 to 5.

It is also preferred in the hard coat layer-forming composition of the invention to use two or more kinds of (b) compounds having three or more functional groups in one molecule.

As (b) compounds having three or more functional groups in one molecule, compounds having a polymerizable functional group (a polymerizable unsaturated double bond) such as a methacryloyl group, a vinyl group, a styryl group, or an allyl group are exemplified, and compounds having a methacryloyl group or —C(O)OCH═CH₂ are preferred. Especially preferably, the following compounds having three or more methacryloyl groups in one molecule can be used.

The specific examples of the compounds having polymerizable functional groups include alkylene glycol (meth)acrylic diesters, polyoxyalkylene glycol (meth)acrylic diesters, polyhydric alcohol (meth)acrylic diesters, ethylene oxide or propylene oxide adduct (meth)acrylic diesters, epoxy (meth)acrylates, urethane (meth)acrylates, and polyester (meth)acrylates.

Esters of polyhydric alcohol and (meth)acrylic acid are preferred above all. For example, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl) isocyanurate are exemplified.

A mass average molecular weight Mwb of (b) a compound having three or more functional groups in one molecule is 100<Mwb<1,600. From the viewpoint of restraint of interference fringes by formation of gradation region and improvement of hardness, Mwb is preferably 200<Mwb<1,600.

The mass average molecular weight is measured as polystyrene equivalent mass average molecular weight by gel permeation chromatography.

An SP value SPb by Hoy method of (b) a compound having three or more functional groups in one molecule is 19<SPa<24.5. From the viewpoint of restraint of interference fringes by formation of gradation region, SPa is preferably 19.5<SPb<24.5, and more preferably 20<SPa<24.5.

The SP (solubility parameter) value in the invention is a value computed by the Hoy method. The Hoy method is described in Polymer Handbook, Fourth Edition.

The ratio of mass average molecular weight Mwb of (b) a compound having three or more functional groups in one molecule and the number of functional groups in one molecule is 70<(Mwb/(number of functional groups in one molecule))<300, preferably 70<(Mwb/(number of functional groups in one molecule))<290, and more preferably 70<(Mwb/(number of functional groups in one molecule))<280. By bringing the ratio of mass average molecular weight Mwb and the number of functional groups into this range, the density of crosslinked groups becomes high and hardness can be increased.

Beside, when two or more kinds of compound having three or more functional groups in one molecule are concurrently used, it is preferable that a mean value of the concurrently used compounds is within the above range with respect to (Mwb/(number of functional groups in one molecule)).

As (b) a compound having three or more functional groups in one molecule, commercially available products can also be used. For example, as polyfunctional acrylate compounds having a (meth)acryloyl group, KAYARAD DPHA, DPCA-30, PET30 (manufactured by Nippon Kayaku Co., Ltd.) can be exemplified. As polyurethane acrylates, 15HA, U4HA, UA306H, EB5129 (manufactured by Shin-Nakamura Chemical Co., Ltd.) can be exemplified.

The content of (b) a compound having three or more functional groups in one molecule in the hard coat layer-forming composition according to the invention is, for giving sufficient rate of polymerization to obtain high hardness, preferably 40% by mass to 70% by mass based on all the solids content in the hard coat layer-forming composition, more preferably 45% by mass to 65% by mass, still more preferably 50% by mass to 65% by mass, and most preferably 55% by mass to 65% by mass.

### <(c) Solvent>

(c) A solvent capable of dissolving and swelling a transparent base material to be contained in the hard coat layer-forming composition according to the invention is explained below.

Solvent (c) for use in the hard coat layer-forming composition according to the invention is a solvent having properties capable of dissolving and swelling a transparent base material.

By the properties of solvent (c) capable of dissolving and swelling a transparent base material, interface reflection between a transparent base material and a hard coat layer can be controlled, so that interference fringes can be effectively restrained.

Here, a solvent having a property capable of dissolving a transparent base material in the invention means a solvent as follows: A base material film having a size of 24 mm×36 mm (thickness: 80 μm) is put in a bottle of the capacity of 15 cc containing a solvent and dipped for 60 seconds under room temperature (25° C.). After the base material film is taken out, the dipping solution is analyzed by gel permeation chromatography (GPC), and when the peak area of the base material component shows 400 mV/sec or more, such a solvent is a solvent having a property capable of dissolving the film. Alternatively, a base material film having a size of 24 mm×36 mm (thickness: 80 μm) is put in a bottle of the capacity of 15 cc containing a solvent and aged for 24 hours, and when the film is completely dissolved and the shape of the film is lost by arbitrarily shaking the bottle, such a solvent is also a solvent having a property capable of dissolving the film.

Further, a solvent having a property capable of swelling a transparent base material means a solvent as follows: A base material film having a size of 24 mm×36 mm (thickness: 80 μm) is lengthwise put in a bottle of the capacity of 15 cc containing a solvent and dipped for 60 seconds under room temperature (25° C.). When bending or deformation of the base material film is observed by arbitrarily shaking the bottle, such a solvent is a solvent having a property capable of swelling the transparent base material. (The swollen part of a film is followed by a change in the dimension and is observed as bending or deformation. A change such as bending or deformation is not observed with a solvent free from a property capable of swelling.)

Solvent (c) may be a solvent having both functions of dissolving and swelling properties to a transparent base material, or may be a mixed solvent containing one or more kinds of each of a first solvent having a property capable of dissolving a transparent base material and a second solvent having a property capable of swelling a transparent base material. Two or more kinds of a solvent having both functions of dissolving and swelling properties to a transparent base material may be used in combination.

Taking the case of using a triacetyl cellulose film as a transparent base material as an example, a solvent having a dissolving property or a swelling property is described below.

As a first solvent having a property capable of dissolving a base material, for example, methyl acetate, acetone, and methylene chloride are exemplified.

As a second solvent having a property capable of swelling a base material, for example, methyl ethyl ketone (MEK) is exemplified.

As a solvent having neither a dissolving property nor a swelling property to a triacetyl cellulose film, for example, methyl isobutyl ketone (MIBK) is exemplified. In the invention, such a solvent having neither a dissolving property nor a swelling property can also be used so long as the advantage of the invention is not damaged. For obtaining the advantage of a solvent having dissolving and swelling properties, the amount of a solvent having neither a dissolving property nor a swelling property is preferably 10% by mass or less based on all the solvents used, more preferably 5% by mass or less, and especially preferably 1% by mass or less.

From the aspect of suppression of interference fringes by the formation of a gradation region between a transparent base material and a hard coat layer, it is preferred for solvent (c) to contain at least one of methyl acetate, acetone, and methyl ethyl ketone. A mixed solvent containing methyl acetate or acetone (the above first solvent), and methyl ethyl ketone (the above second solvent) is preferred.

From the aspect of suppression of interference fringes by the formation of a gradation region between a transparent base material and a hard coat layer, solvent (c) is a mixed solvent containing respectively one or more of the above first solvent having a property capable of dissolving a base material and the second solvent having a property capable of swelling a base material, and the proportion of the first solvent is preferably higher than the proportion of the second solvent in all the solvents. The proportion of the first solvent and the second solvent ((first solvent)/(second solvent)) in all the solvents is preferably 50/50 to 95/5 from the viewpoint of the formation of a gradation region preferred for restraining interference fringes and from the aspect of film hardness of the hard coat layer.

The entire amount of the solvents in the hard coat layer-forming composition of the invention is preferably as the concentration of the solid content in the composition of 1% by mass to 70% by mass, more preferably 20% by mass to 70% by mass, still more preferably 40% by mass to 70% by mass, still further preferably 45% by mass to 65% by mass, especially preferably 50% by mass to 65% by mass, and most preferably 55% by mass to 65% by mass.

### <(d) Photopolymerization Initiator>

The hard coat layer-forming composition according to the invention preferably contains (d) a photopolymerization initiator.

The examples of photopolymerization initiators include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins. Preferred specific examples, preferred modes, and commercially available products of photopolymerization initiators are described in JP-A-2009-098658, paragraphs (0133) to (0151) and these can be preferably used in the invention.

Various examples are also described in Saishin UV Koka Gijutsu (The Latest UV Curing Techniques), p. 159, published by Gijutsu Joho Kyokai (1991), and Kiyoshi Kato, Shigaisen Koka System (UV Ray Curing System), pp. 65 to 148, published by Sogo Gijutsu Center (1989), and these are useful for the invention.

The content of the photopolymerization initiator in the hard coat layer forming composition according to the invention is preferably 0.5% by mass to 8% by mass based on all the solids content in the hard coat layer-forming composition, and more preferably 1% by mass to 5% by mass, for the reason that the content is determined to be a sufficiently large amount to polymerize the polymerizable compound contained in the hard coat layer-forming composition and a sufficiently small amount so that the initiating point does not rise too high.

### <(e) Leveling Agent>

Leveling agents (e) which may be contained in the hard coat layer-forming composition of the invention are described below.

The leveling agent is preferably at least either one selected from the following fluorine-containing polymer (1) and fluorine-containing polymer (2).

Fluorine-containing polymer (1) is a polymer containing more than 50% by mass of a polymerization unit deriving from a fluoro-aliphatic group-containing monomer represented by the following formula [1].

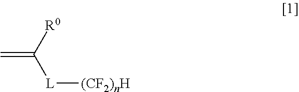

In formula [1], R⁰ represents a hydrogen atom, a halogen atom, or a methyl group; L represents a divalent linking group; and n represents an integer of 1 to 18.

In fluorine-containing polymer (1), the content of the repeating unit deriving from the fluoro-aliphatic group-containing monomer represented by formula [1] exceeds 50% by mass of all the polymerization units constituting fluorine-containing polymer (1), preferably 70% by mass or more, and more preferably 80% by mass or more.

In formula [1], R⁰ represents a hydrogen atom, a halogen atom, or a methyl group, and preferably a hydrogen atom or a methyl group.

n represents an integer of 1 to 18, preferably 4 to 12, more preferably 6 to 8, and most preferably 8.

In fluorine-containing polymer (1) may be contained two or more kinds of polymerization units of the fluoro-aliphatic group-containing monomer represented by formula [1] as constituent units.

In fluorine-containing polymer (1), formula [1] is preferably formula [1-2].

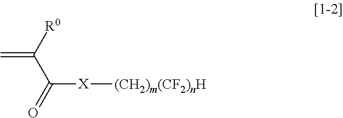

In formula [1-2], R⁰ represents a hydrogen atom, a halogen atom, or a methyl group; X represents an oxygen atom, a sulfur atom, or —N(R²) —; m represents an integer of 1 to 6; n represents an integer of 1 to 18; and R² represents a hydrogen atom or an alkyl group having 1 to 8 carbon atoms which may have a substituent.

In formula [1-2], R⁰ represents a hydrogen atom, a halogen atom, or a methyl group, and preferably a hydrogen atom or a methyl group.

X represents an oxygen atom, a sulfur atom, or —N(R²)—, preferably an oxygen atom or —N(R²)—, and more preferably an oxygen atom. R² represents a hydrogen atom or an alkyl group having 1 to 8 carbon atoms which may have a substituent, and the examples of the substituents include a phenyl group, a benzyl group, and ether oxygen, preferably a hydrogen atom or an alkyl group having 1 to 4 carbon atoms which may have a substituent, and more preferably a hydrogen atom or a methyl group.

m represents an integer of 1 to 6; preferably 1 to 3, and more preferably 1.

n represents an integer of 1 to 18; preferably 4 to 12, more preferably 6 to 8, and most preferably 8.

In fluorine-containing polymer (1) may be contained two or more kinds of polymerization units of the fluoro-aliphatic group-containing monomer represented by formula [1-2] as constituent units.

Fluorine-containing polymer (2) is described below.

Fluorine-containing polymer (2) is a polymer containing a polymerization unit derived from the fluoro-aliphatic group-containing monomer represented by formula [2], and a polymerization unit derived at least either selected from poly(oxyalkylene)acrylate and poly(oxyalkylene)methacrylate.

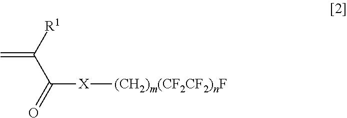

In formula [2], R¹ represents a hydrogen atom or a methyl group; X represents an oxygen atom, a sulfur atom, or —N(R²)—; m represents an integer of 1 to 6; n represents an integer of 1 to 3; and R² represents a hydrogen atom or an alkyl group having 1 to 4 carbon atoms.

One of fluoro-aliphatic groups in fluorine-containing polymer (2) is preferably a group derived from fluoro-aliphatic compound manufactured by a telomerization method (also referred to as a telomere method) or an oligomerization method (also referred to as an oligomer method). Manufacturing methods of these fluoro-aliphatic compounds are described in Fusso Kagobutsu no Gosei to Kinou (Syntheses and Functions of Fluorine Compounds), pp. 117-118, compiled by Nobuo Ishikawa, published by CMC Publishing Co., Ltd. (1987), and Chemistry of Organic Fluorine Compounds II, pp. 747-752 (Monograph 187, Ed. By Milos Hudlicky and Attila E. Pavlath, American Chemical Society, 1995).

As the specific examples of fluoro-aliphatic group-containing monomers [1] and [2], and fluorine-containing polymers (1) and (2), the specific examples disclosed in JP-A-2010-1549434, JP-A-2010-121137, JP-A-2004-331812, and JP-A-2004-163610 can be exemplified, but the invention is not restricted to these compounds.

As leveling agents, the fluoro-aliphatic group-containing polymers disclosed in Japanese Patent 4474114 are also preferred. As those which are the same with but different in compositional ratios from the fluoro-aliphatic group-containing polymers in Japanese Patent 4474114, fluoro-aliphatic group-containing polymers having the ratios of polymerization unit containing fluoro-aliphatic group in the range of 50% to 70% can also be used as leveling agents.

In the invention, for solving coating unevenness of a hard coat layer, a leveling agent is preferably sufficiently deposited on the surface of the hard coat layer. However, when an antireflection layer is laminated on the hard coat layer, if the leveling agent contained in the hard coat layer remains at the interface between the hard coat layer and the antireflection layer, adhesion property is deteriorated and scratch resisting property is conspicuously depleted. Accordingly, it is important that the leveling agent is rapidly extracted into the antireflection layer at the time of lamination of the antireflection layer and does not remain at the interface. Fluorine-containing polymer (1) is preferred to polymer (2), for the reason that the terminal of the fluoro-aliphatic group of polymer (1) is a hydrogen atom and is harder to repel the upper layer coating solution than polymer (2) having a fluorine atom terminal, and so polymer (1) is rapidly extracted into the upper layer, and difficult to remain at the interface between the antireflection layer and the hard coat layer.

The content of the leveling agent in the hard coat layer-forming composition of the invention is preferably 0.0005% by mass to 2.5% by mass on the basis of all the solids content in the hard coat layer-forming composition, and more preferably 0.005% by mass to 0.5% by mass, for the reason that the content is necessary to be determined as small as possible but sufficient to be capable of giving satisfactory leveling property to improve coating unevenness and not remaining at the interface between the hard coat layer and other layers.

### <(f) Silica Particles>

The particle size (primary particle size) of silica particles usable in the hard coat layer-forming composition of the invention is preferably 15 nm or more and less than 100 nm, more preferably 20 nm or more and 80 nm or less, and most preferably 25 nm or more and 60 nm or less. The average particle size of particles can be found from an electron microphotograph. When the particle size of inorganic particles is too small, effect to heighten uneven distribution on the surfaces of particles of a leveling agent lowers, while when the particle size is too large, minute unevenness occurs on the surface of the hard coat layer, as a result external appearance such as denseness of black and integrated reflectance are deteriorated. Silica particles may be crystalline or amorphous, and may be monodispersed particles or aggregated particles so long as the prescribed particle size is satisfied. As the shape, a spherical shape is most preferred but undefined shapes other than spherical may be used with no problems. Two or more kinds of silica particles having different average particle sizes may be used in combination.

Silica particles that can be used in the invention may be subjected to surface treatment for the purpose of improvements of dispersibility in a coating solution and film strength. Specific surface treatments and preferred examples are described in JP-A-2007-298974, paragraphs (0119) to (0147) and these are applicable to the invention.

Specific examples of silica particles include MiBK-ST, MiBK-SD (silica sol, average particle size: 15 nm, manufactured by Nissan Chemical Industries, Ltd.), MEK-ST-L (silica sol, average particle size: 50 nm, manufactured by Nissan Chemical Industries, Ltd.), and these particles can be preferably used in the invention.

The hard coat layer-forming composition according to the invention may also contain additives other than those described above. As additives that can be further used, a UV ray absorber, phosphite, hydroxamic acid, hydroxylamine, imidazole, hydroquinone and phthalic acid can be exemplified for the purpose of suppressing decomposition of polymers. In addition, inorganic particles, polymer particles and a silane coupling agent for the purpose of increasing film strength, a fluorine compound (in particular, a fluorine surfactant) for the purpose of lowering a refractive index to heighten transparency, and matting particles for the purpose of imparting an internal scattering property can be exemplified.

### <Layer Constitution of Optical Film>

The optical film in the invention has a hard coat layer on a transparent base material and, further, according to necessity, a single or multiple layers of necessary functional layers may be provided. For example, an antireflection layer (a layer the refractive index of which is adjusted, such as a low refractive index layer, a middle refractive index layer, a high refractive index layer), and an antiglare layer may be provided.

More specific examples of layer constitutions of optical films in the invention are as follows.

Transparent base material/hard coat layer
Transparent base material/hard coat layer/low refractive index layer
Transparent base material/hard coat layer/high refractive index layer/low refractive index layer
Transparent base material/hard coat layer/middle refractive index layer/high refractive index layer/low refractive index layer

### <Transparent Base Material>

In the optical film in the invention, various materials can be used as a transparent base material, but cellulose ester film is preferred and cellulose acylate film is most preferred.

A cellulose acylate film is not especially restricted but when it is mounted on a display, a cellulose triacylate film can be used as it is as a protective film for protecting the polarizing layer of a polarizing plate, so that a cellulose triacylate film is especially preferred in the point of productivity and costs.

The thickness of a transparent base material is generally 25 μm to 1,000 μM or so, but 25 μm to 200 μm is preferred for easy handling and capable of obtaining necessary base material strength.

### <Cellulose Acylate>

In the invention, it is preferred to use cellulose acetate having a degree of acetylation of 59.0% to 61.5% as a cellulose acylate film. A degree of acetylation means a combined acetic acid amount per a unitary mass of cellulose. A degree of acetylation can be measured according to measurement and computation of a degree of acetylation in ASTM D-817-91 (a test method of a celluose acetate). The viscosity average degree of polymerization (DP) of cellulose acylate is preferably 250 or more and more preferably 290 or more.

Further, it is preferred that the value of Mw/Mn (Mw is a mass average molecular weight and Mn is a number average molecular weight) by gel permeation chromatography of the cellulose acylate for use in the invention is close to 1.0, i.e., molecular weight distribution is narrow. The specific value of Mw/Mn is preferably 1.0 to 1.7, more preferably 1.3 to 1.65, and more preferably 1.4 to 1.6.

In general, the hydroxyl groups at the 2-, 3- and 6-positions of cellulose acylate are not equally distributed to every one-third of the degree of substitution of the whole, and the degree of substitution of the hydroxyl groups at the 6-position is liable to be small. In the cellulose acylate in invention, it is preferred that the degree of substitution of the hydroxyl groups at the 6-position is larger as compared with the 2- and 3-positions.

It is preferred that the hydroxyl groups at the 6-position are substituted with acyl groups in the ratio of 32% or more on the basis of the whole degree of substitution, more preferably 33% or more, and especially preferably 34% or more. Further, in the cellulose acylate in invention, the degree of substitution with acyl groups at the 6-position is preferably 0.88 or more. The hydroxyl groups at the 6-position may be substituted with an acyl group having 3 or more carbon atoms such as a propionyl group, a butyroyl group, a valeroyl group, a benzoyl group, or an acryloyl group, besides an acetyl group. The degree of substitution at each position can be found by NMR.

As the cellulose acylate in the invention, the cellulose acetates obtained by the methods disclosed in JP-A-11-5851, paragraphs (0043) and (0044) (Example, Synthesis Example 1), paragraphs (0048) and (0049) (Synthesis Example 2), and paragraphs (0051) and (0052) (Synthesis Example 3) can be used.

### <Physical Properties of Hard Coat Layer>

The refractive index of the hard coat layer formed of the hard coat layer forming composition is generally 1.45 or more and 1.55 or less from the optical design for obtaining suppression of interference fringes and an antireflection property, preferably 1.46 or more and 1.54 or less, and more preferably 1.48 or more and 1.54 or less.

From the aspect of providing sufficient durability and impact resistance to the film, the thickness of the hard coat layer is generally 0.5 μm to 20 μm, preferably 1 μm to 15 μm, and more preferably 3 μm to 13 μm. The thickness of the later-described gradation region is not included in the thickness of the hard coat layer.

It is also preferred that the hard coat layer has strength of H or higher in the pencil hardness test, more preferably 2H or higher, and most preferably 3H or higher. Further, the less the abrasion of the test piece before and after in Taber rest according to JIS K5400, the better.

When the optical film according to the invention is applied to an image display having a high contrast ratio, the hard coat layer is preferably a clear hard coat layer showing high transparency. That is, the haze of the hard coat layer is preferably 1.0% or less, and more preferably 0.01% to 0.7%. The haze can be measured according to JIS K-6714 with a haze meter HGM-2DP (manufactured by Suga Test Instruments Co., Ltd.).

### <Antireflection Layer>

### (Low Refractive Index Layer)

It is preferred for the optical film in the invention to have an antireflection layer (a low refractive index layer or the like) directly on the hard coat layer or through other layers. In this case, the optical film in the invention can function as an antireflection film.

When a low refractive index layer is provided directly on the hard coat layer, the low refractive index layer is preferably a thin layer having a thickness of 200 nm or less. Further, it is sufficient to form a low refractive index layer in a layer thickness of about one-fourth of designed wavelength as optical layer thickness. However, in the case of performing antireflection by one layer of a low refractive index layer that is the simplest constitution of one layer-film interference type, there are no practical low refractive index materials satisfying refractive index of 0.5% or less, having a neutral tint, high scratch resisting property, chemical resistance and weather resistance, if further reduction of reflection is necessary, it is sufficient to form a multilayer-film interference type antireflection film, such as two layer-film interference type forming a high refractive index layer between the hard coat layer and the low refractive index layer, or a three layer-film interference type forming a middle refractive index layer and a high refractive index layer in order between the hard coat layer and the low refractive index layer.

In this case the refractive index of the low refractive index layer is preferably 1.30 to 1.51, more preferably 1.30 to 1.46, and still more preferably 1.32 to 1.38. By the above range of the refractive index, reflectance can be preferably controlled and film strength can be maintained. A low refractive index layer can be formed by a chemical vapor deposition method (CVD) and a physical vapor deposition method (PVD), and a transparent film of inorganic oxide can be used by, in particular, a vacuum deposition method and a sputtering method, one of physical vapor deposition methods, but it is preferred to use a method by all-wet coating with a low refractive index layer-forming composition.

The low refractive index layer is not especially limited so long as the layer has the refractive index within the above range. Known constituents, specifically compositions containing a fluorine-containing resin for curing and inorganic particles as disclosed in JP-A-2007-298974, and hollow silica particle-containing low refractive index coatings as disclosed in JP-A-2002-317152, JP-A-2003-202406 and JP-A-2003-292831 can be preferably used.

### (High Refractive Index Layer and Middle Refractive Index Layer)

The refractive index of the high refractive index layer is preferably 1.65 to 2.20, and more preferably 1.70 to 1.80. The refractive index of the middle refractive index layer is adjusted so as to be a value between the refractive index of the low refractive index layer and the refractive index of the high refractive index layer. The refractive index of the middle refractive index layer is preferably 1.55 to 1.65, and more preferably 1.58 to 1.63.

A high refractive index layer and a middle refractive index layer can be formed by a chemical vapor deposition method (CVD) and a physical vapor deposition method (PVD), and a transparent film of inorganic oxide can also be used by, in particular, a vacuum deposition method and a sputtering method, one of physical vapor deposition methods, but it is preferred to use a method by all-wet coating.

The middle refractive index layer and high refractive index layer are not especially restricted so long as they have the refractive indices within the above ranges. Known constituents can be used, specifically they are disclosed in JP-A-2008-262187, paragraphs (0074) to (0094).

### (Gradation Region)

In the optical film according to the invention, a gradation region in which distribution of the compounds (base material components and hard coat layer components) gradually changes from the transparent base material side toward the hard coat layer side is present between the transparent base material and the hard coat layer.

Here, the hard coat layer is a part in which the hard coat layer components alone are contained and the base material components are not contained, and the base material is a part not containing the hard coat layer components.

The thickness of the gradation region is preferably 5% or more and 200% or less of the hard coat layer thickness from the viewpoint of restraint of interference fringes, more preferably 5% or more and 150% or less, and most preferably 5% or more and 95% or less.

The reason why the above range is preferred is that the thinner the gradation region, the thicker can be formed the hard coat layer, so that good hard coat property (high hardness and low curl) is liable to be maintained.

When a film is cut with a microtome and the cross section is analyzed with a time-of-flight secondary ion mass spectrometer (TOF-SIMS), the gradation region can be measured as a part where both the base material components and the hard coat layer components are detected. The thickness of the region can be similarly measured from the data of the cross section of TOF-SIMS.

### (Manufacturing Method of Optical Film)

The optical film in the invention can be formed by the following method, but the invention is not restricted thereto.

In the first place, a hard coat layer-forming composition is prepared. Subsequently, the composition is coated on a transparent base material by any of a dip coating method, an air knife coating method, a curtain coating method, a roller coating method, a wire bar coating method, a gravure coating method and a die coating method, and then the coated composition is heated and dried. A micro gravure coating method, a wire bar coating method, and a die coating method (refer to U.S. Pat. No. 2,681,294 and JP-A-2006-122889) are more preferred, and a die coating method is especially preferred.

After coating, the coated composition is subjected to drying and light exposure for curing, thus a hard coat layer is formed. If necessary, it is also possible to coat other layers on a transparent base material in advance and then form a hard coat layer thereon. The optical film of the invention is obtained in this manner. Further, other layers as described above can also be provided according to necessity. In the manufacturing method of the optical film according to the invention, two or more layers may be coated at the same time, or may be coated one after another.

### <Optical Film Having Low PV Value>

The invention is an optical film having a clear hard coat layer (haze is 1.0% or less) on a transparent base material and also relates to an optical film having a peak strength PV value of the power spectrum of 0.000 to 0.006. The power spectrum is obtained by Fourier transform of reflectance spectrum measured by an optical interferometry. PV value is preferably 0.000 to 0.003.

PV value is described below in the first place.

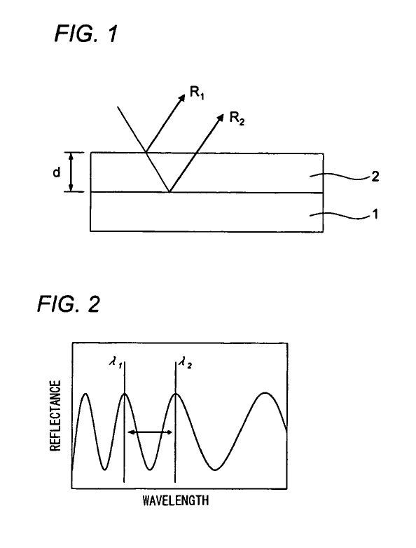

Taking a film 2 (film thickness: d) having been coated on a base material 1 shown in FIG. 1 as the example, the incident light from the upper side of the object sample reflects on the surface of film 2 (R1), and further, the light penetrated the film reflects at the interface of base the material 1 and the film 2 (R2). The reflectance spectrum as shown in FIG. 2 is obtained by light interference caused by the phase deviation due to the optical path difference at this time. Since the positions and numbers of the peaks and valleys of the reflectance spectrum depend upon the wavelength of the incident light, the refractive index n of the film and the film thickness d, the thickness of the film can be computed from the peak wavelength and valley wavelength. For example, a film thickness can be computed from the distance between two peaks λ₁ and λ₂. When the reflectance is small and the influence of a noise is great, detection of peak and valley from the reflectance spectrum is difficult and there is a case where a correct film thickness cannot be obtained. By performing Fourier transform, even such a reflectance spectrum is hardly affected by a noise and the thicknesses of multilayer can also be analyzed. Specifically, when the reflectance spectrum is subjected to Fourier transform to obtain a power spectrum and the power spectrum thereof is observed, each spectrum has a peak at the place of optical film thickness value (refractive index×film thickness nd), and by reading the peak value, the film thickness of the corresponding film can be found. In the case of multilayer, the spectrum becomes a spectrum having a product of the refractive index and the film thickness of each layer, that is, a spectrum having a period resulting from the optical film thickness, so that it becomes possible to extract the optical film thickness of each layer.

PV value is a value to indicate the magnitude of reflection, and means peak strength of a power spectrum obtained by fast Fourier transform of variation resulting from a thin film interference of reflectance spectrum. If the refractive index difference at the interface is small, the peak strength is small, and as the refractive index difference becomes large, the peak strength becomes large.

In the invention, of peak strengths corresponding to two interfaces between the transparent base material and the gradation layer, and between the gradation layer and the hard coat layer in the above power spectrum, the greater value is taken as PV value and the index of interference fringes. The smaller the value, the more controlled is the interference fringes. In practice, in the case where PV values are detected at both the interfaces even the PV values are the same, as compared with the case where PV value is detected at only one interface, it is known that the level of interference fringes is bad. This is for the reason that the amount of interface reflection of the latter almost doubles of the former.

In an optical film having a PV value of 0.000 to 0.006, the above-described transparent base material can be used as a transparent base material. The clear hard coat layer means a hard coat layer having a haze of 1% or less and, for example, such a clear hard coat layer can be formed from the above hard coat layer-forming compositions.

An optical film having a PV value of 0.000 to 0.006 can also be manufactured according to the following method (1) or (2).

(1) The refractive index of a hard coat layer is brought close to the refractive index of a transparent base material and the absolute value of the refractive index difference between the transparent base material and the hard coat layer is decreased. The hard coat layer is formed by using also a solvent having a property capable of dissolving the transparent base material. As the methods to decrease the absolute value of the refractive index difference between the transparent base material and the hard coat layer, a method of using a material having a refractive index close to that of the transparent base material is used in the hard coat layer, and a method of adjusting the degree of curing of the hard coat layer are exemplified.
(2) A solvent having properties capable of dissolving and swelling the transparent base material is used in a hard coat layer-forming composition, and diffusion of a curable compound (monomer) into the transparent base material is adjusted by interference conditions. For example, accelerating diffusion of the monomer into the base material by applying heat from the back side of the transparent base material with a heater, or slowing drying speed can be exemplified.

### <Protective Film for Polarizing Plate>

When the optical film is used as a surface protective film (a protective film for a polarizing plate) of a polarizing film, the surface of a transparent base material opposite to the side having a film layer, that is, the surface of the side to be stuck to the polarizing film, is hydrophilized. Adhesion of the optical film to the polarizing film mainly comprising polyvinyl alcohol can be improved.

It is also preferred that, of two protective films of a polarizer, films other than the optical film are optically compensatory films having an optically compensatory layer having an optically anisotropic layer. An optically compensatory film (a phase difference film) can improve viewing angle characteristics of the image plane of a liquid crystal display.

As optically compensatory films, known films can be used, but in the point of widening viewing angle, the optically compensatory films disclosed in JP-A-2001-100042 are preferably used.

The above saponification treatment is described. The saponification treatment is treatment of dipping an optical film in a heated alkali aqueous solution for a certain period of time, and after washing the film with water, washing with an acid for neutralization. Any treatment conditions may be applied so long as the side of the transparent base material to be stuck to a polarizing film is hydrophilized, and the concentration of treating agent, the temperature of the treating agent solution and treating time may be arbitrarily determined, but generally from the necessity to secure productivity, treating conditions are decided so that the treatment can be carried out in three minutes. As general conditions, alkali concentration is 3% by mass to 25% by mass, the temperature of treatment is 30° C. to 70° C., and treating time is 15 sec to 5 min. As alkalis for use in alkali treatment, sodium hydroxide and potassium hydroxide are preferred, as acid for use in acid washing, sulfuric acid is preferred, and as water for use in water washing, ion exchange water and pure water are preferred.

The antistatic property of the antistatic layer of the optical film in the invention is well maintained by saponification treatment even when exposed to an alkali aqueous solution.

When the optical film in the invention is used as the surface protective film (a protective film for a polarizing plate) of a polarizing film, a cellulose acylate film is preferably a cellulose triacetate film.

### <Polarizing Plate>

A polarizing plate in the invention is described.

A polarizing plate in the invention is a polarizing plate having a polarizing film and two sheets of protective films for protecting both surfaces of the polarizing film, and at least either one of the protective films is the optical film or antireflection film of the invention.

There are iodine-based polarizing films, dye-based polarizing films using dichroic dyes, and polyene-based polarizing films in polarizing films. Iodine-based polarizing films and dye-based polarizing films can be generally manufactured with polyvinyl alcohol films.

A constitution in which a cellulose acylate film of an optical film is adhered to a polarizing film through a polyvinyl alcohol adhesive layer according to necessity, and the other side of the polarizing film also has a protective film is preferred. The side opposite to the side of the polarizing film having a protective film may have an adhesive layer.

By using the optical film of the invention as a protective film for a polarizing plate, a polarizing plate excellent in physical strength, an antistatic property and durability can be manufactured.

The polarizing plate of the invention may have optically compensatory performance. In that case, it is preferred that either one surface alone of the obverse or reverse of two sheets of surface protective films is formed with the above optical film, and the surface protective film on the side opposite to the side of the polarizing plate having the optical film is the optically compensatory film.

By manufacturing a polarizing plate using the optical film of the invention on one side of a protective film for a polarizing plate and optionally compensatory film having an optically anisotropic property on the other side of the protective film, contrast of a liquid crystal display in a bright room and viewing angles of the upper and lower sides and right and left can further be improved.

### <Image Display>

An image display according to the invention has the optical film, antireflection film or polarizing plate of the invention on the outermost surface.

The optical film, antireflection film and polarizing plate of the invention can be preferably used in image display devices such as a liquid crystal display (LCD), a plasma display panel (PDP), an electroluminescence display (ELD) and a cathode ray tube (CRT).

In particular, they can be advantageously used in image display devices such as a liquid crystal display, and it is especially preferred to use them as the outermost surface layer on the backlight side of the liquid crystal cell in transmission type and semi-transmission type liquid crystal displays.

In general, a liquid crystal display has two sheets of polarizing plates arranged in a liquid crystal cell and on both sides thereof, and the liquid crystal cell carries liquid crystal between two electrodes. Further, there are cases where one optically anisotropic layer is arranged between a liquid crystal cell and a polarizing plate on one side, or two optically anisotropic layers are arranged between a liquid crystal cell and polarizing plate on both sides.

Liquid crystal cell is preferably TN mode, VA mode, OCB mode, IPS mode or ECB mode.

### EXAMPLES

The invention will be described in further detail with reference to examples, however, the scope of the invention is by no means restricted thereto. In the examples “parts” and “%” mean by mass unless otherwise indicated.

### <Manufacture of Optical Film>

A coating solution for forming each layer is prepared as shown below and each layer is formed, and optical film samples 1 to 18 are manufactured.

### (Preparation of Coating Solution for Hard Coat Layer)

The following composition is put in a mixing tank, stirred, and filtered through a polypropylene filter having a pore size of 0.4 μm to obtain coating solution A-1 for a hard coat layer (solid content concentration: 64% by mass).

| | |
|---|---|
| Solvent (shown in Table 1) | 18.5 parts by mass |
| | (sum total in the |
| | case of two or more) |
| (a) Monomer: Blenmer E | 1.53 parts by mass |
| (b) Monomer: PET 30 | 30.59 parts by mass |
| Photopolymerization initiator (Irgacure | 0.91 parts by mass |
| 184 (manufactured by Chiba Japan K.K.)) | |
| Leveling agent (SP-13) | 0.006 parts by mass |

Each of coating solutions A-2 to A-17 for a hard coat layer having solid content concentration of 64% by mass is manufactured in the same manner as in the manufacture of coating solution A-1 for a hard coat layer by mixing each component, dissolving in a solvent as shown in Table 1 below, and adjusting to the ratio shown in Table 1.

TABLE 1

| | (a) Monomer | | | | |
|---|---|---|---|---|---|
| | | Mass Average | | Number of | Addition Amount (% by mass) (ratio to |
| Coating | | Molecular | SP | Functional | the gross amount of the materials of |
| Solution | Kind | Weight (Mw) | Value | Groups | three-functional or more ((b) component) (%) |
| A-1 | Blenmer E | 130 | 24.3 | 1 | 5 |
| A-2 | Blenmer E | 130 | 24.3 | 1 | 5 |
| A-3 | Blenmer GMR | 228 | 21.9 | 2 | 5 |
| A-4 | Blenmer E | 130 | 24.3 | 1 | 5 |
| A-5 | None | — | — | — | — |
| A-6 | Blenmer E | 130 | 24.3 | 1 | 12 |
| A-7 | Blenmer E | 130 | 24.3 | 1 | 20 |
| A-8 | Blenmer GLM | 160 | 26.5 | 1 | 5 |
| A-9 | Blenmer DMA | 226 | 18.6 | 1 | 5 |
| A-10 | DPHA | 559 | 20.1 | 5.5 | 5 |
| A-11 | SP327 | 450 | 20.3 | 3 | 5 |
| A-12 | Blenmer E | 130 | 24.3 | 1 | — |
| A-13 | Blenmer E | 130 | 24.3 | 1 | 5 |
| A-14 | Blenmer E | 130 | 24.3 | 1 | 5 |
| A-15 | Blenmer E | 130 | 24.3 | 1 | 5 |
| A-16 | Blenmer E | 130 | 24.3 | 1 | 5 |
| A-17 | Blenmer E | 130 | 24.3 | 1 | 5 |

| | (b) Monomer | | | | | (c) Solvent | |
|---|---|---|---|---|---|---|---|
| | | Mass Average | | Number of | Mw/Number | | Ratio of |
| Coating | | Molecular | SP | Functional | of Functional | | Solvents |
| Solution | Kind | Weight (Mw) | Value | Groups | Groups | Kind | (by mass) |
| A-1 | PET 30 | 298 | 21.6 | 3.4 | 87.6 | Methyl acetate/ | 50/50 |
| | | | | | | methyl ethyl ketone | |
| A-2 | ET 30 | 298 | 21.6 | 3.4 | 87.6 | Methyl acetate/ | 50/50 |
| | (80% by mass) | | | | | methyl ethyl ketone | |
| | Urethane | 596 | 22.29 | 4 | 149 | | |
| | monomer | | | | | | |
| | (20% by mass) | | | | | | |
| A-3 | PET 30 | 298 | 21.6 | 3.4 | 87.6 | Methyl acetate/ | 50/50 |
| | | | | | | methyl ethyl ketone | |
| A-4 | PET 30 | 298 | 21.6 | 3.4 | 87.6 | Methyl acetate/ | 50/50 |
| | (80% by mass) | | | | | methyl ethyl ketone | |
| | EB 5129 | 765 | 22.07 | 6 | 127.5 | | |
| | (20% by mass) | | | | | | |
| A-5 | PET 30 | 298 | 21.6 | 3.4 | 87.6 | Methyl acetate/ | 50/50 |
| | | | | | | methyl ethyl ketone | |
| A-6 | PET 30 | 298 | 21.6 | 3.4 | 87.6 | Methyl acetate/ | 50/50 |
| | | | | | | methyl ethyl ketone | |
| A-7 | PET 30 | 298 | 21.6 | 3.4 | 87.6 | Methyl acetate/ | 50/50 |
| | | | | | | methyl ethyl ketone | |
| A-8 | PET 30 | 298 | 21.6 | 3.4 | 87.6 | Methyl acetate/ | 50/50 |
| | | | | | | methyl ethyl ketone | |
| A-9 | PET 30 | 298 | 21.6 | 3.4 | 87.6 | Methyl acetate/ | 50/50 |
| | | | | | | methyl ethyl ketone | |
| A-10 | PET 30 | 298 | 21.6 | 3.4 | 87.6 | Methyl acetate/ | 50/50 |
| | | | | | | methyl ethyl ketone | |
| A-11 | PET 30 | 298 | 21.6 | 3.4 | 87.6 | Methyl acetate/ | 50/50 |
| | | | | | | methyl ethyl ketone | |
| A-12 | None | — | — | — | — | Methyl acetate/ | 50/50 |
| | | | | | | methyl ethyl ketone | |
| A-13 | DPCA 30 | 921 | 20.1 | 6 | 153.5 | Methyl acetate/ | 50/50 |
| | | | | | | methyl ethyl ketone | |
| A-14 | A-9300 | 423 | 26.0 | 3 | 141 | Methyl acetate/ | 50/50 |
| | | | | | | methyl ethyl ketone | |
| A-15 | DPCA 120 | 1,947 | 19.8 | 6 | 324.5 | Methyl acetate/ | 50/50 |
| | | | | | | methyl ethyl ketone | |
| A-16 | Urethane monomer | 596 | 22.29 | 4 | 149 | Methyl isobutyl | 100 |
| | | | | | | ketone | |
| A-17 | Urethane monomer | 596 | 22.29 | 4 | 149 | Methyl ethyl ketone | 100 |

Compounds used above are shown below.

Leveling agent (SP-13): The compound having the structure shown below.

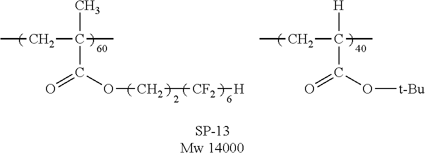

Blenmer E: The compound having the structure shown below. Mass average molecular weight: 130, the number of functional group in one molecule: 1 (manufactured by NOF Corporation).

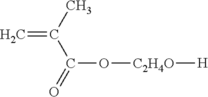

Blenmer GLM: The compound having the structure shown below. Mass average molecular weight: 160, the number of functional group in one molecule: 1 (manufactured by NOF Corporation).

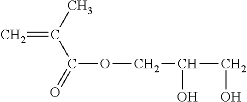

Blenmer GMR: The compound having the structure shown below. Mass average molecular weight: 228, the number of functional group in one molecule: 2 (manufactured by NOF Corporation).

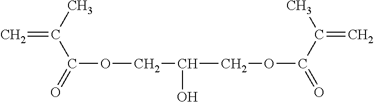

Blenmer DMA: The compound having the structure shown below. Mass average molecular weight: 226, the number of functional group in one molecule: 1 (manufactured by NOF Corporation).

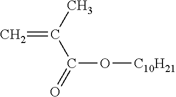

DPHA: Mixture of dipentaerythritol pentaacrylate and dipentaerythritol hexaacrylate, mass average molecular weight: 559, the number of functional group in one molecule: 5.5 (on average) (manufactured by Nippon Kayaku Co., Ltd.).
SP327: The compound having the structure shown below. Mass average molecular weight: 450, the number of functional group in one molecule: 3 (manufactured by Osaka Organic Chemical Industry Ltd.).

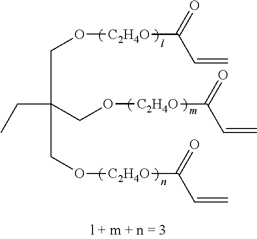

PET30: The compound having the structure shown below. Mass average molecular weight: 298, the number of functional group in one molecule: 3.4 (on average) (manufactured by Nippon Kayaku Co., Ltd.).

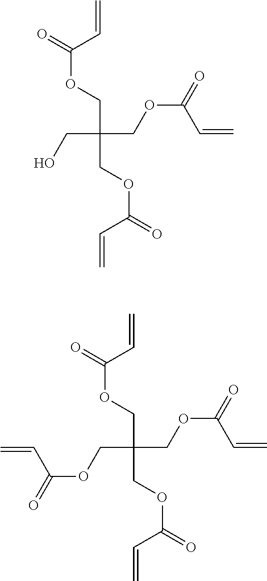

Urethane monomer: The compound having the structure shown below. Mass average molecular weight: 596, the number of functional group in one molecule: 4.

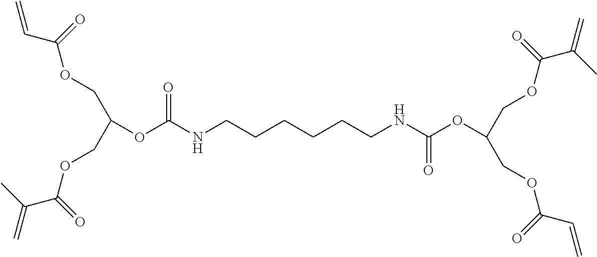

EB5129: The compound having the structure shown below. Mass average molecular weight: 765, the number of functional group in one molecule: 6 (manufactured by Daicel Chemical Industries, Ltd.).

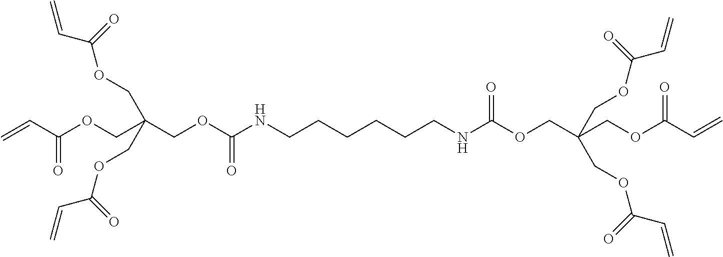

DPCA30: The compound having the structure shown below. Mass average molecular weight: 921, the number of functional group in one molecule: 6 (manufactured by Nippon Kayaku Co., Ltd.).

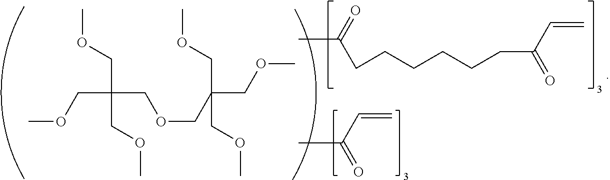

DPCA120: The compound having the structure shown below. Mass average molecular weight: 1,947, the number of functional group in one molecule: 6 (manufactured by Nippon Kayaku Co., Ltd.).

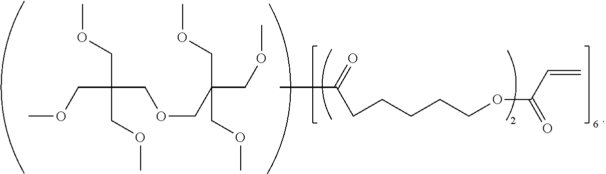

A-9300: The compound having the structure shown below. Mass average molecular weight: 423, the number of functional group in one molecule: 3 (manufactured by Shin-Nakamura Chemical Co., Ltd.).

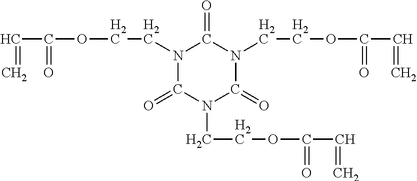

### (Preparation of Coating Solution for Low Refractive Index Layer)

### (Synthesis of Perfluoroolefin Copolymer (1))

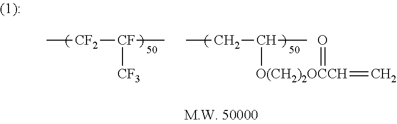

In the above structural formula, 50/50 means a molar ratio. A stainless steel autoclave equipped with a stirrer having a capacity of 100 mL is charged with 40 mL of ethyl acetate, 14.7 g of hydroxyethyl vinyl ether, and 0.55 g of dilauroyl peroxide, deaerated, and replaced with nitrogen gas. Further, 25 g of hexafluoropropylene (HFP) is introduced into the autoclave and temperature is increased to 65° C. At the time when the temperature in the autoclave reaches 65° C., the pressure is 0.53 MPa (5.4 kg/cm²). The reaction is continued for 8 hours while maintaining that temperature, and when the pressure reaches 0.31 MPa (3.2 kg/cm²), heating is stopped and the reaction system is allowed to be cooled. When the temperature lowers to room temperature, unreacted monomer is taken out, autoclave is opened and the reaction solution is taken out. The obtained reaction solution is thrown into excessive amount of hexane, the solvent is removed by decantation, and the precipitated polymer is taken out. The monomer is dissolved in a small amount of ethyl acetate and reprecipitated two times from hexane to thereby completely remove the residual monomer. After drying, 28 g of the polymer is obtained. In the next place, 20 g of the polymer is dissolved in 100 mL of N,N-dimethylacetamide, 11.4 g of acrylic acid chloride is dripped while cooling with ice, and stirred at room temperature for 10 hours. Ethyl acetate is added to the reaction solution and washed with water, organic layer is extracted and the reaction solution is concentrated. The obtained polymer is reprecipitated with hexane to obtain 19 g of a perfluoroolefin copolymer (1). The refractive index of the obtained polymer is 1.422 and the mass average molecular weight is 50,000.

### (Preparation of Hollow Silica Particle Dispersion A)

To 500 parts by mass of hollow silica particle (isopropyl alcohol silica sol, CS60-IPA, manufactured by Catalysts & Chemicals Ind. Co., Ltd., average particle size: 60 nm, shell thickness: 10 nm, silica concentration: 20% by mass, refractive index of silica particles: 1.31) are added 30 parts by mass of acryloyloxypropyl-trimethoxysilane, and 1.51 parts by mass of diisopropoxy aluminum ethyl acetate, and mixed, and then 9 parts by mass of ion exchange water is added. Reaction is continued at 60° C. for 8 hours, and then cooled to room temperature, and 1.8 parts by mass of acetylacetone is added to thereby obtain dispersion. After that, solvent substitution is carried out by reduced pressure distillation of pressure of 30 Torr so that the silica content becomes almost constant with adding cyclohexanone, and solid content concentration of 18.2% by mass of dispersion A is obtained by adjusting concentration. The residual amount of IPA of the obtained dispersion A is 0.5% by mass or less from gas chromatograpy analysis.

### (Preparation of Coating Solution a for Low Refractive Index Layer)

To methyl ethyl ketone are added 21.0 parts by mass of perfluoroolefin copolymer (1), 2.5 parts by mass of reactive silicone X22-164C (manufactured by Shin-Etsu Chemical Co., Ltd.), 1.5 parts by mass of Irgacure 127 (manufactured by Ciba Japan K.K.), and 137.4 parts by mass of hollow silica particle dispersion A to make 1,000 parts by mass, stirred, and filtered through a polypropylene filter having a pore size of 5 μm to prepare low refractive index layer-coating solution A.

### (Manufacture of Hard Coat Layer A-1)

The above coating solution A-1 for a hard coat layer is coated with a gravure coater on a triacetyl cellulose film (TD80UF, manufactured by Fuji Photo Film Co., Ltd., refractive index: 1.48) having a thickness of 80 μm as a transparent base material in a coating amount shown in Table 2 below. After drying at 100° C., coated layer is cured with an air-cooling metal halide lamp (manufactured by iGraphics) of 160 W/cm, while nitrogen purging so that oxygen concentration reaches the atmosphere of 1.0% by volume or less by UV-ray exposure at intensity illumination of 60 mW/cm² and exposure amount of 120 mJ/cm², to thereby form hard coat layer A-1, thus optical film No. 1 is manufactured.

In the same manner, each of hard coat layer A-2 to A-18 is prepared with coating solution A-2 to A-17 for a hard coat layer, thus film sample Nos. 2 to 18 are manufactured.

The refractive index of the hard coat layer of each sample measured by the following method is in the range of 1.45 to 1.55.

The haze of each hard coat layer is measured according to JIS K-6714 with a haze meter HGM-2DP (manufactured by Suga Test Instruments Co., Ltd.). The results of measurement are shown in Table 2.

### (Manufacture of Low Refractive Index Layer A)

A low refractive index layer having a thickness of 94 nm is formed by coating low refractive index layer-coating solution A. on the hard coat layer of each film with a gravure coater. After drying the low refractive index layer at 60° C. for 60 sec, UV-ray exposure is carried out with an air-cooling metal halide lamp (manufactured by iGraphics) of 240 W/cm, while nitrogen purging so that oxygen concentration reaches the atmosphere of 0.1% by volume or less at intensity illumination of 600 mW/cm² and exposure amount of 300 mJ/cm². The refractive index of the low refractive index layer is 1.36.

The refractive indices of each hard coat layer and low refractive index layer are measured by coating each coating solution on a glass plate so that each coating solution has about 4 μm thickness and measured with a multi-wavelength Abbe's refractometer DR-M2 (manufactured by Atago Co., Ltd.). The refractive index measured with a filter (interference filter for DR-M2 and M4 546 (e) nm, parts number: RE-3523) is adopted as the refractive index at wavelength 550 nm.

The thickness of each low refractive index layer is computed with a reflection spectral thickness meter FE-3000 (manufactured by Otsuka Electronics Co., Ltd.). The refractive index of each layer is obtained by adjusting the obtained value by the above Abbe's refractometer.

### (Evaluation of Optical Film)

Various characteristics of each optical film are evaluated. The results obtained are shown in Table 2 below.

### (1) PV Value, Interference Fringes

In regard to each sample, a sample not provided with a low refractive index layer is manufactured on the same condition, and the reverse side of the transparent base material (the surface of the side on which a hard coat layer is not provided) is rubbed with sand paper and a PET film painted black is stuck on that part. The sample is set on the reflection spectral thickness meter FE-3000 (manufactured by Otsuka Electronics Co., Ltd.) and a reflectance spectrum is found with a 3-wavelength light source. The obtained reflectance spectrum is subjected to Fourier transform and power spectrum to the optical thickness is obtained. The peak strength from the interface of the transparent base material and hard coat layer is found as PV value from the obtained power spectrum. The measuring condition and computation condition at the time of performing Fourier transform in FE-3000 are as follows.

### (Condition of Measurement)

Measuring method: absolute reflectance
Measuring mode: manual

### (Condition of Computation)

Material category: standard

### Algorithm: FFT

Computing method: 2-layer 2-peak
n1d1 system: FIX refractive index: designation of the refractive index of the hard coat layer measured according to the above method
n2d2 system: FIX refractive index: designation of the average value of the above refractive index of the base material and the refractive index of the hard coat layer measured according to the above method

Interference fringes are evaluated according to the following criteria on the basis of the obtained PV value.

A: PV value is 0.000 or more and 0.003 or less.
B: PV value is higher than 0.003 and 0.006 or less.
C: PV value is higher than 0.006.
(2) Curl, F-type curl

### (Evaluation Method of F-Type Curl)

Each manufactured sample is cut to a sample having a size of 3 mm×35 mm and the cut sample is exactly set on a curl plate perpendicularly so as not to protrude from the prop on which the sample is set, and humidified at 25° C. 60% RH for 10 hours. After humidification, the scale whereto the tip of the sample curls is read (F-type curl value). At this time±is attached according to the direction to which the film curls, but the greater the absolute value, the stronger is the curl.

Curl of each film (absolute value) is evaluated according to the following criteria.

A: 0.5 or less.
B: Higher than 0.5 and 1.5 or less.
C: Higher than 1.5.
(3) Pencil hardness

Pencil hardness evaluation is performed by the method described in JIS K5400, and evaluated according to the following criteria.

A: 4H or more.

### B: 3H

C: Less than 2H.

TABLE 2

| | | Coating Amount of | Haze of | | | | | | | |
|---|---|---|---|---|---|---|---|---|---|---|
| Optical | Hard Coat Layer | Solid Content of Hard | Hard Coat | PV | Interference | F-Type | | Pencil Hardness | | |
| Film No. | Coating Solution | Coat Layer (g/m²) | Layer (%) | Value | Fringes | Curl | Curl | Hardness | Evaluation | Remarks |
| 1 | A-1 | 14.0 | 0.2 | 0.002 | A | 0.3 | A | 4H | A | Invention |
| 2 | A-2 | 14.0 | 0.2 | 0.001 | A | 0.3 | A | 4H | A | Invention |
| 3 | A-1 | 9.1 | 0.2 | 0.003 | A | 0.9 | B | 3H | B | Invention |
| 4 | A-3 | 9.1 | 0.2 | 0.003 | A | 1.1 | B | 3H | B | Invention |
| 5 | A-4 | 14.0 | 0.2 | 0.001 | A | 1.5 | B | 4H | A | Invention |
| 6 | A-5 | 9.1 | 0.2 | 0.012 | C | 1.5 | B | 3H | B | Comparison |
| 7 | A-6 | 9.1 | 0.2 | 0.002 | A | 0.7 | B | 2H | C | Comparison |
| 8 | A-7 | 9.1 | 0.2 | 0.004 | B | 0.6 | B | 2H | C | Comparison |
| 9 | A-8 | 9.1 | 0.2 | 0.012 | C | 1.1 | B | 3H | B | Comparison |
| 10 | A-9 | 9.1 | 0.2 | 0.02 | C | 1.1 | B | 3H | B | Comparison |
| 11 | A-10 | 9.1 | 0.2 | 0.025 | C | 3.2 | C | 4H | A | Comparison |
| 12 | A-11 | 9.1 | 0.2 | 0.009 | C | 1.5 | B | 3H | B | Comparison |
| 13 | A-12 | 9.1 | 0.2 | 0.001 | A | 0.1 | A | H | C | Comparison |
| 14 | A-13 | 9.1 | 0.2 | 0.05 | C | 4.0 | C | H | C | Comparison |
| 15 | A-14 | 9.1 | 0.2 | 0.03 | C | 2.8 | C | H | C | Comparison |
| 16 | A-15 | 9.1 | 0.2 | 0.02 | C | 3.6 | C | H | C | Comparison |
| 17 | A-16 | 9.1 | 0.2 | 0.03 | C | 0.5 | A | 3H | B | Comparison |
| 18 | A-17 | 9.1 | 0.2 | 0.015 | C | 1.0 | B | 3H | B | Comparison |

As shown in Table 2, the optical films in the invention are high in hardness and interference fringes and curl are controlled.

### (Saponification Treatment of Optical Film)

Sample No. 1 is subjected to the following treatment. A sodium hydroxide aqueous solution (1.5 mol/L) is prepared and the temperature is maintained at 55° C. A dilute sulfuric acid aqueous solution (0.01 mol/L) is prepared and maintained warm at 30° C. The prepared optical film is dipped in the sodium hydroxide aqueous solution for 2 minutes, and then dipped in water and the sodium hydroxide aqueous solution is thoroughly washed away. Subsequently, the film is dipped in the above dilute sulfuric acid aqueous solution 20 sec, and then dipped in water and the dilute sulfuric acid aqueous solution is thoroughly washed away. Lastly the sample is sufficiently dried at 120° C.

Thus, an optical film having been subjected to saponification treatment is manufactured.

### (Manufacture of Polarizing Plate)

A triacetyl cellulose film (TAC-TD80U, manufactured by Fuji Photo Film Co., Ltd.) having a thickness of 80 μm (1.5 mol/L), which has been dipped in an NaOH aqueous solution for 2 minutes and then neutralized and washed with water, and the optical film subjected to saponification treatment are adhered to both surfaces of a polarizer, which is manufactured by adsorbing iodine onto polyvinyl alcohol and stretching, and protected to thereby manufacture a polarizing plate.

### (Manufacture of Circular Polarizing Plate)

A circular polarizing plate is manufactured by sticking λ/4 plate on the surface of the side opposite to the side on which a low refractive index layer is provided of the polarizing plate sample with an adhesive, and the circular polarizing plate is adhered to the surface of an organic EL display with an adhesive such that the low refractive index layer is on the outside. Good display performance free from scratching and color unevenness can be obtained.

The above circular polarizing plate is used as the surface polarizing plate of each of a reflection type liquid crystal display and a semi-transmission type liquid crystal display such that the low refractive index layer is on the outside. Good display performance free from scratching and color unevenness can be obtained.

Incidentally, when the above triacetyl cellulose film is replaced with a film having a thickness of 60 μm (TAC-TD60U manufactured by Fuji Photo Film Co., Ltd.), good display performance free from scratching and color unevenness can be obtained.

What is claimed is:

1. An optical film comprising: a transparent base material; and a hard coat layer formed of a composition for forming the hard coat layer, the composition containing following (a), (b) and (c):
(a) a first compound having two or less functional groups in one molecule, the first compound having a mass average molecular weight Mwa that satisfies 40<Mwa<500 and having a SP value SPa that satisfies 19<SPa<24.5, wherein the SP value is defined by the Hoy method,
(b) a second compound having three or more functional groups in one molecule, the second compound having a mass average molecular weight Mwb that satisfies 100<Mwb<1,600 and 70<(Mwb/(number of functional groups in one molecule))<300 and having a SP value SPb that satisfies 19<SPb<24.5, wherein the SP value is defined by the Hoy method, and
(c) a solvent capable of dissolving and swelling the transparent base material,
wherein the hard coat layer has a refractive index of 1.45 to 1.55, and a content of the first compound (a) is from 0.5% by mass to 10% by mass to a content of the second compound (b).

2. The optical film as claimed in claim 1, wherein the solvent (c) contains at least one of methyl acetate, acetone and methyl ethyl ketone.

3. The optical film as claimed in claim 1, wherein Mwa of the first compound (a) satisfies 30<Mwa<250.

4. The optical film as claimed in claim 1, wherein SPa of the first compound (a) satisfies 22<SPa<24.5.

5. The optical film as claimed in claim 1, wherein the composition contains two or more compounds as the second compound (b), at least one of which is a urethane compound.

6. The optical film as claimed in claim 1, wherein the solvent (c) contains at least one first solvent capable of dissolving the transparent base material, and at least one second solvent having capable of swelling the transparent base material, wherein a proportion of the first solvent is higher than a proportion of the second solvent in all solvents.

7. The optical film as claimed in claim 1, wherein the transparent base material is a cellulose acylate film.

8. The optical film as claimed in claim 1, wherein the hard coat layer has a haze of 1.0% or less.

9. An optical film comprising: a transparent base material; and a hard coat layer having a haze of 1.0% or less, wherein the optical film has a peak strength PV value of a power spectrum of 0.000 to 0.006, the power spectrum being obtained by a Fourier transform of a reflectance spectrum of the optical film measured by an optical interferometry.

10. The optical film as claimed in claim 9, wherein the PV value is 0.000 to 0.003.

11. A polarizing plate comprising an optical film described in claim 1 as a protective film for the polarizing plate.

12. An image display comprising an optical film described in claim 1.

13. A method for manufacturing an optical film described in claim 1, the method comprising: coating the composition for forming the hard coat layer on the transparent base material; and curing the composition to form the hard coat layer.
